(19) United States
(12) Patent Application Publication
(10) Pub. No.: US 2010/0177071 A1
(43) Pub. Date: Jul. 15, 2010

(54) DISPLAY CONTROL METHODS AND SYSTEMS

(75) Inventor: Yao-Wen Chu, La Palma, CA (US)

Correspondence Address: QUINTERO LAW OFFICE, PC, 615 Hampton Dr, Suite A202, Venice, CA, 90291, US

(73) Assignee: TATUNG COMPANY OF AMERICA, INC., Long Beach, CA (US)

(21) Appl. No.: 12/353,942

(22) Filed: Jan. 14, 2009

(51) Int. Cl. G09G 5/00

(52) U.S. Cl. 345/205

(57) ABSTRACT

Display control methods and systems are provided. The display control system includes a panel including a plurality of pixels, and a processor. The processor provides a video signal having a high level to the pixels, and periodically forces at least one of the pixels to be OFF.

### BACKGROUND OF THE INVENTION

1. Field of the Invention

The disclosure relates generally to display control methods and systems, and, more particularly to methods and systems that periodically force at least one pixel to be OFF.

2. Description of the Related Art

With the advanced development of displays, flat panels, such as plasma panels or LCD panels are in widespread use. A drawback of flat panel displays is a persistent image situation. Due to the component property of panels, panels tend to keep a persistent image of fixed images that have been displayed a little too long. For example, when a monitor displays content with a bright portion, such as a white portion, the bright portion may be slightly seen for a certain amount of time, despite having any input content to the monitor. The persistent image situation occurs most often for surveillance, gaming and data information display applications since a static or still picture with high contrast scenes are always displayed at a same position for a long period of time, wherein corresponding pixels are fully or almost fully ON.

In the conventional art for reducing the persistent image situation, when content is displayed, the position of the content is shifted and displayed after a specific period, such that the corresponding pixels may display different portions of the content, thus reducing the persistent image situation. In practice, since the portion which may cause the persistent image always affects a block of pixels, the position of the content must be shifted beyond the range of the block or else the persistent image situation will still exist. However, when the position of the content is shifted beyond the range of the block, users can easily notice the shift of the content, wherein smooth viewing for users is disturbed.

### BRIEF SUMMARY OF THE INVENTION

Display control methods and systems are provided.

In an embodiment of a display control method, a video signal is provided to a plurality of pixels of a panel. Then, at least one of the pixels is periodically forced to be OFF.

An embodiment of a display control system includes a panel including a plurality of pixels, and a processor. The processor provides a video signal to the pixels, and periodically forces at least one of the pixels to be OFF.

In some embodiments, the at least one pixel is forced to be off by applying a reverse pulse to the at least one pixel.

Display control methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a display control system of the invention;

FIG. 2 is a flowchart of an embodiment of a display control method of the invention;

FIG. 3 is a flowchart of another embodiment of a display control method of the invention;

FIG. 4 is a flowchart of further another embodiment of a display control method of the invention;

FIG. 5A is a schematic diagram illustrating a panel displaying content with a bright portion;

FIG. 5B is a schematic diagram illustrating video signals corresponding to the content in FIG. 5A;

FIG. 5C is a schematic diagram illustrating pixels corresponding to the bright portion in FIG. 5A and its adjacent pixels;

FIG. 6 is a schematic diagram illustrating pixels corresponding to the bright portion in FIG. 5A and a corresponding reverse pulse according to an embodiment of a display control of the invention; and

FIG. 7 is a schematic diagram illustrating pixels corresponding to the bright portion in FIG. 5A and a corresponding reverse pulse according to an embodiment of a display control of the invention.

### DETAILED DESCRIPTION OF THE INVENTION

Display control methods and systems are provided.

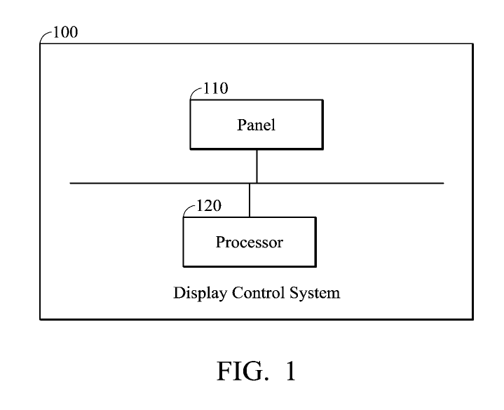

FIG. 1 is a schematic diagram illustrating an embodiment of a display control system of the invention.

The display control system 100 may be a flat panel display, such as an LCD display. The display control system 100 comprises a panel 110 and a processor 120. The panel 110 comprises a plurality of pixels (not shown) arranged in rows and columns. Each pixel may receive a video signal with a specific level, such as from 0 to 1 Vp-p, and performs display according to the received video signal. In some embodiments, each pixel may comprise a switch element, such as a transistor, and a storage capacitor used for control of liquid crystal molecules. The processor 120 can program video signals corresponding to content expected to be displayed, and provide the video signals to the panel 110, such that the respective pixels can display specific portions of the content according to the corresponding video signals. The processor 120 further performs the display control methods of the invention. Related detail is discussed later.

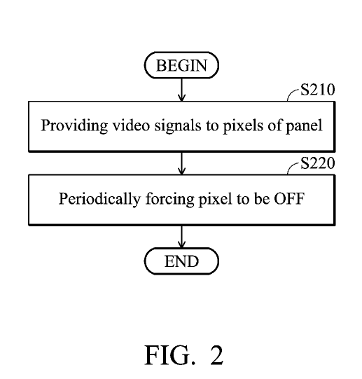

FIG. 2 is a flowchart of an embodiment of a display control method of the invention.

In step S210, video signals are provided to pixels of a panel. Then, in step S220, at least one of the pixels is selected and periodically forced to be OFF. In some embodiments, the pixel is periodically forced to be OFF by turning off the pixel for a predefined period, and turning on the pixel after the predefined period. It is understood that, in some embodiments, the pixel is forced to be OFF by turning off the switch element, such as the transistor of the pixel. Additionally, in some embodiments, the pixel is forced to be OFF by applying a reverse pulse to the pixel. It is noted that, the above embodiments for forcing the pixel to be OFF are examples of the invention, and the invention is not limited thereto.

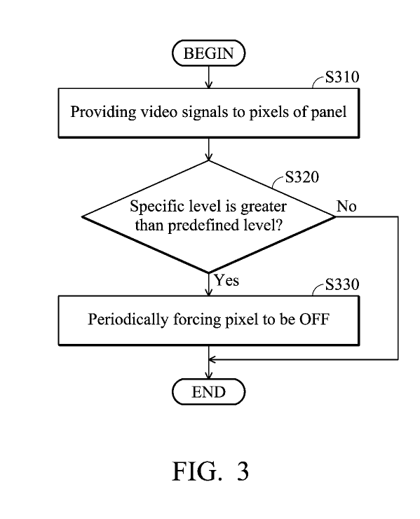

FIG. 3 is a flowchart of another embodiment of a display control method of the invention.

In step S310, video signals are provided to pixels of a panel. It is understood that the video signal for the respective pixel may has a specific level, such as 0 to 1 Vp-p. In step S320, it is determined whether the specific level of the video signal for the respective pixel is greater than a predefined level, such as 0.8 Vp-p. When the specific level of the video signal for the respective pixel is not greater than the predefined level (No in step S320), the pixel does not need to be forced OFF, and the procedure is completed. When the specific level of the video signal for the respective pixel is greater than the predefined level (Yes in step S320), for example, the video signal indicates the respective pixel to display a bright portion or a white portion, in step S330, at least one of the pixels with a specific level is greater than the predefined level is selected and periodically forced to be OFF. It is understood that, in some embodiments, the pixel to be periodically OFF is selected randomly among the pixels with specific levels greater than the predefined level. In some embodiments, all of the pixels with specific levels greater than the predefined level are averagely selected to be forced OFF. Further, in some embodiments, the number of the pixel to be selected can be determined according to a ratio of the number of pixels with specific levels greater than the predefined level to the number of pixels of the panel, the number of pixels of the panel, and/or the diameter of the pixel. For example, two separated pixels can be selected to be simultaneously forced OFF. It is noted that, the selection manner and number of the pixels of the invention are not limited thereto. Similarly, the pixel is periodically forced to be OFF by turning off the pixel for a predefined period, and turning on the pixel after the predefined period. In some embodiments, the pixel is forced to be OFF by turning off the switch element, such as the transistor of the pixel, or by applying a reverse pulse to the pixel.

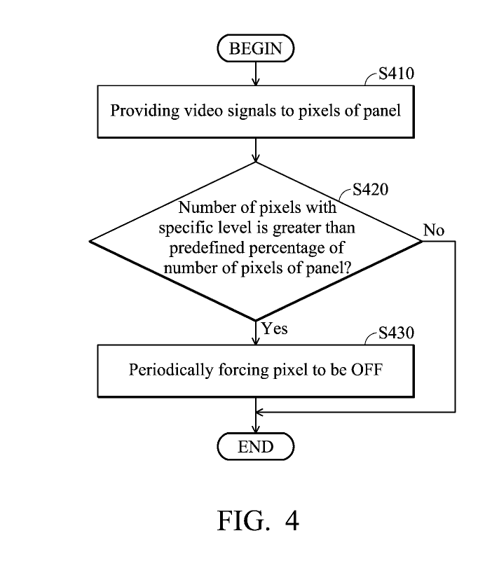

FIG. 4 is a flowchart of another embodiment of a display control method of the invention.

In step S410, video signals are provided to pixels of a panel. It is understood that the video signal for the respective pixel may has a specific level, such as 0 to 1 Vp-p. In step S420, it is determined whether the number of pixels with a specific level greater than a predefined level, such as 0.8 Vp-p is greater than a predefined percentage, such as 80% of the number of pixels of the panel. When the number of pixels with specific levels greater than the predefined level is not greater than the predefined percentage of the number of pixels of the panel (No in step S420), the pixels do not need to be forced OFF, and the procedure is completed. When the number of pixels with specific levels greater than the predefined level is greater than the predefined percentage of the number of pixels of the panel (Yes in step S420), in step S430, at least one of the pixels with a specific level greater than the predefined level is selected and periodically forced to be OFF. Similarly, in some embodiments, the pixel to be periodically OFF is selected randomly among the pixels with specific levels greater than the predefined level. In some embodiments, all of the pixels with specific levels greater than the predefined level are averagely selected to be forced OFF. Further, in some embodiments, the number of the pixel to be selected can be determined according to a ratio of the number of pixels with specific levels greater than the predefined level to the number of pixels of the panel, the number of pixels of the panel, and/or the diameter of the pixel. It is noted that, the selection manner and number of the pixels of the invention are not limited thereto. Similarly, the pixel is periodically forced to be OFF by turning off the pixel for a predefined period, and turning on the pixel after the predefined period. In some embodiments, the pixel is forced to be OFF by turning off the switch element, such as the transistor of the pixel, or by applying a reverse pulse to the pixel.

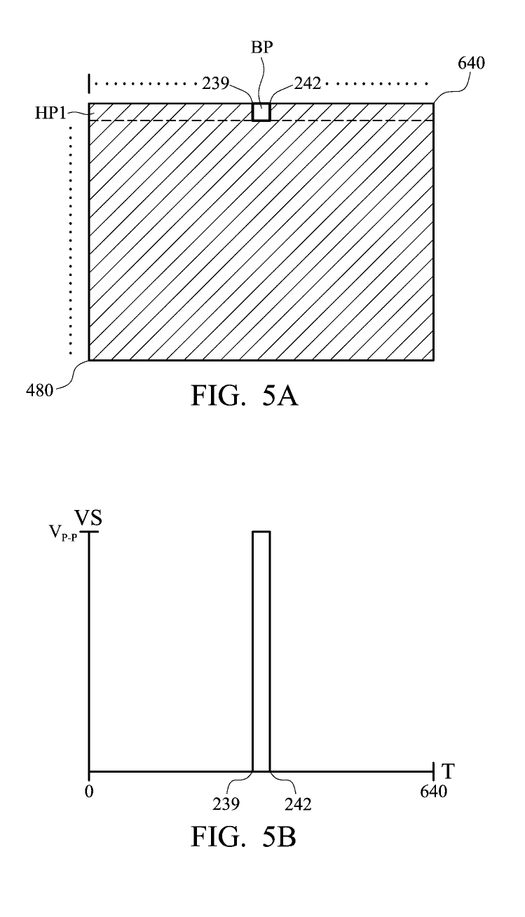

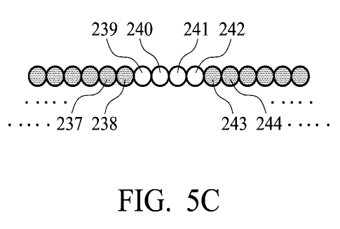

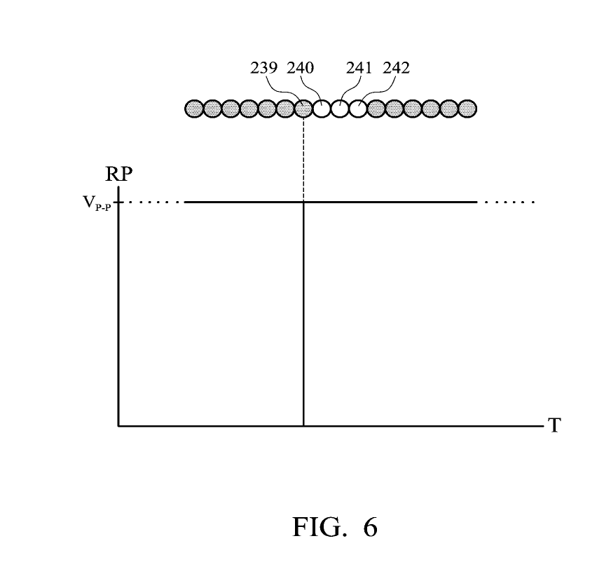

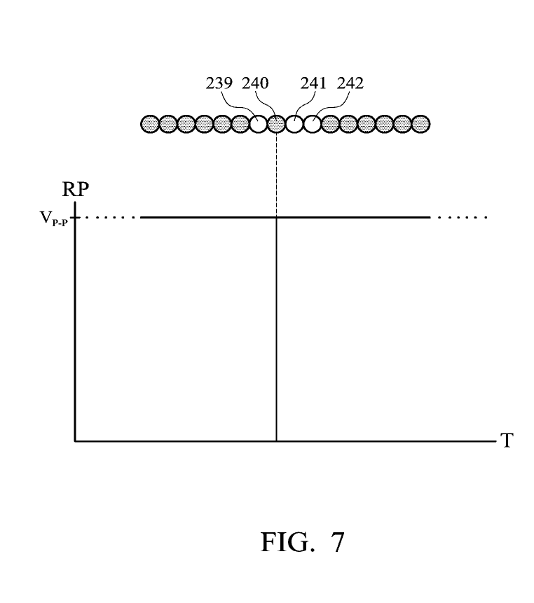

An example illustrating a panel displaying content with a bright portion is as follows. FIG. 5A is a schematic diagram illustrating a panel displaying content with a bright portion. In FIG. 5A, a panel has 640*480 pixels, and only the pixels 239 to 242 in the first horizontal period (HP1) of the image (content) is a bright portion (BP), such as a white scene and other pixels are dark portions, such as black scenes. FIG. 5B is a schematic diagram illustrating video signals of the first horizontal period corresponding to the content in FIG. 5A, wherein the video signals corresponding to pixels 239 to 242 have a level of 1 Vp-p. FIG. 5C is a schematic diagram illustrating pixels corresponding to the bright portion in FIG. 5A and its adjacent pixels, wherein the pixels 239 to 242 corresponding to the bright portion are fully ON or almost fully ON, and the adjacent pixels (237, 238, 243, 244 . . . ) are OFF. In embodiments of display control of the invention, at least one of the pixels 239 to 242 can be selected and periodically forced to be OFF. In an embodiment, pixel 239 can be selected and forced to be OFF by applying a corresponding reverse pulse (RP), as shown in FIG. 6. After a predefined period, the reverse pulse for pixel 239 can be cancelled, such that the pixel 239 can display the bright portion based on the video signal. Additionally, pixel 240 can be selected and forced to be OFF by applying a corresponding reverse pulse (RP), as shown in FIG. 7. The selection of pixels and periodically forcing pixels to be OFF are repeated.

Therefore, the display control methods and systems can periodically force at least one pixel to be OFF to reduce the persistent image situation.

Display control methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A display control method, comprising:
providing a video signal to a plurality of pixels of a panel; and
periodically forcing at least one of the pixels to be OFF.

2. The method of claim 1, wherein the step of periodically forcing the at least one pixel to be OFF is performed by turning off the at least one pixel for a predefined period and turning on the at least one pixel after the predefined period.

3. The method of claim 2, wherein the step of turning off the at least one pixel is performed by turning off a transistor of the at least one pixel.

4. The method of claim 2, wherein the step of turning off the at least one pixel is performed by applying a reverse pulse to the at least one pixel.

5. The method of claim 1, wherein the video signal has a specific level, and the method further comprises the steps of:
determining whether the specific level of the video signal is greater than a predefined level; and
when the specific level of the video signal is greater than the predefined level, periodically forcing the at least one pixel to be OFF.

6. The method of claim 5, wherein each of the pixels displays a bright portion based on the video signal.

7. The method of claim 5, wherein the video signal has a specific level, and the specific level is greater than a predefined level, and the method further comprises the steps:
determining whether the number of pixels receiving the video signal is greater than a predefined percentage of the number of pixels of the panel; and
when the number of pixels receiving the video signal is greater than the predefined percentage of the number of pixels of the panel, periodically forcing the at least one pixel to be OFF.

8. The method of claim 1, further comprising randomly selecting the at least one pixel to be periodically OFF.

9. The method of claim 1, wherein the number of the at least one pixel to be periodically OFF is determined according to a ratio of the number of pixels receiving the video signal to the number of pixels of the panel, the number of pixels of the panel, or the diameter of the pixel.

10. A display control system, comprising:
a panel comprising a plurality of pixels; and
a processor providing a video signal to the pixels, and periodically forcing at least one of the pixels to be OFF.

11. The system of claim 10, wherein the processor periodically forces the at least one pixel to be OFF by turning off the at least one pixel for a predefined period and turning on the at least one pixel after the predefined period.

12. The system of claim 11, wherein the processor turns off the at least one pixel by turning off a transistor of the at least one pixel.

13. The system of claim 11, wherein the processor turns off the at least one pixel is performed by applying a reverse pulse to the at least one pixel.

14. The system of claim 10, wherein the video signal has a specific level, and the processor further determines whether the specific level of the video signal is greater than a predefined level, and when the specific level of the video signal is greater than the predefined level, the at least one pixel is periodically forced to be OFF.

15. The system of claim 14, wherein each of the pixels displays a bright portion based on the video signal.

16. The system of claim 14, wherein the video signal has a specific level, and the specific level is greater than a predefined level, and the processor further determines whether the number of pixels receiving the video signal is greater than a predefined percentage of the number of pixels of the panel, and when the number of pixels receiving the video signal is greater than the predefined percentage of the number of pixels of the panel, the at least one pixel is periodically forced to be OFF.

17. The system of claim 10, wherein the processor further randomly selects the at least one pixel to be periodically OFF.

18. The system of claim 10, wherein the number of the at least one pixel to be periodically OFF is determined according to a ratio of the number of pixels receiving the video signal to the number of pixels of the panel, the number of pixels of the panel, or the diameter of the pixel.
